(19) United States
(12) Patent Application Publication
(10) Pub. No.: US 2008/0064481 A1
(43) Pub. Date: Mar. 13, 2008

(54) GAMING APPARATUS AND METHOD WITH DEPENDENT FEATURE GAME

(76) Inventors: Robert James Jackson, Earlwood (AU); Chi We Chim, Castle Hill (AU)

Correspondence Address: MCANDREWS HELD & MALLOY, LTD, 500 WEST MADISON STREET, SUITE 3400, CHICAGO, IL, 60661, US

(21) Appl. No.: 11/849,763

(22) Filed: Sep. 4, 2007

(30) Foreign Application Priority Data
Sep. 1, 2006 (AU) 2006904872

(51) Int. Cl. A63F 13/00

(52) U.S. Cl. 463/20

(57) ABSTRACT

A method is described for use with a gaming machine that is arranged to select symbols, present the selected symbols on a display and award an award if a winning outcome occurs. A plurality of game options are displayed on the display for selection by a player, each game option defining a respective number of opportunities to win and a corresponding probability of winning in each opportunity, wherein at least two of the displayed game options have a substantially equal return-to-player by specifying the respective number of opportunities to win in inverse proportion to the corresponding probability of winning. In one arrangement the corresponding probability of winning for a game option depends on a number of spinning reels on which a special symbol may appear. A number of games may be varied in inverse proportion to the number of reels on which the special symbol may appear.

### CROSS REFERENCE TO RELATED APPLICATIONS

This application claims priority to Australian Patent Application No. AU2006904872, having an international filing date of Sep. 1, 2006, entitled “Gaming Apparatus and Method with Dependent Feature Game”, which is hereby incorporated by reference herein in its entirety.

### FIELD OF THE INVENTION

The present invention relates to gaming apparatuses and methods of gaming. In a particular embodiment, the present invention relates to a gaming apparatus and method for implementing a game having a feature game.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought-after variety, while still developing games that comply with the relevant regulations in the jurisdiction of the gaming venue operator. Suppliers of gaming devices therefore are faced with restrictions on the types of games and gaming apparatus that are allowable, both in terms of the prevailing regulations and in terms of providing a return on investment to the gaming venue operators.

Existing gaming machines and other gaming apparatus may offer the player feature games. Feature games normally offer an increased return to player and the gaming apparatus must therefore provide enhanced play characteristics in the feature game to provide the required increased return to player. For example, a game may have a return to player of approximately 70% with a hit rate (i.e. the frequency of getting a prize) of about 1 in every 6 games. A feature game of the game may require a return to player of approximately 200% and a hit rate of 1 in 2.

### SUMMARY OF THE INVENTION

Described herein are methods of providing a game in which a plurality of game options are displayed on the display for selection by a player, each game option defining a respective number of opportunities to win and a corresponding probability of winning in each opportunity, wherein at least two of the displayed game options have a substantially equal return-to-player. The respective number of opportunities to win may be inversely dependent on the corresponding probability of winning. In one arrangement the corresponding probability of winning for a game option depends on a number of spinning reels on which a special symbol may appear. A number of games may be varied in inverse proportion to the number of reels on which the special symbol may appear.

According to one aspect of the invention there is provided a method of providing a game played on a computational gaming apparatus having a display and a user interface, the game being a spinning reel game in which at least one symbol is spun up on each of a plurality of spinning reels and displayed on the display to form one or more outcomes and if a particular outcome occurs the gaming apparatus awards an award, each reel having an associated set of symbols, the method comprising:

displaying a plurality of game options, each game option designating a respective number of the spinning reels as having at least one specified symbol in the associated set of symbols;

receiving a selection of one of the displayed game options; and

playing the game according to the received selection, wherein for each spinning reel at least one symbol is randomly selected and displayed on the display, the display of at least one of said specified symbols providing modified play characteristics relative to other symbols in the set of symbols.

In certain embodiments, the modified play characteristics comprise an increased chance of a said particular outcome. In certain embodiments, the modified play characteristics comprise a larger award if one or more said particular outcomes result from the game.

In certain embodiments, the displayed game is a feature game associated with a base game played on the computational gaming apparatus.

In certain embodiments, the method further comprises modifying a parameter of the game other than the number of spinning reels having at least one specified symbol in response to the selection of one of the displayed game options, the parameter of the game acting to maintain a return-to-player of the game regardless of which option is chosen. Where the game is a feature game, the parameter of the game preferably maintains a return to player for the base game and feature game collectively.

According to another aspect of the invention there is provided a gaming apparatus providing a game in which a plurality of spinning reels is displayed, each reel displaying at least one symbol from an associated set of symbols to form one or more outcomes and if a particular outcome occurs the gaming apparatus awards an award, the gaming apparatus comprising:

a display that displays a plurality of game options, each game option designating a respective number of the reels as having at least one specified symbol in the associated set of symbols; and

a game controller in communication with the display and arranged to:

(a) receive an input choosing one of the displayed game options; and

(b) play a game according to the chosen game option, wherein for each spinning reel at least one symbol is randomly selected and displayed on the display, the display of at least one of said specified symbols providing modified play characteristics relative to other symbols in the sets of symbols.

In certain embodiments, the game is a feature game and the gaming apparatus is operable to trigger commencement of the feature game during a base game played on the gaming apparatus.

In certain embodiments, the displayed feature game comprises a series of bonus games and each game option designates a duration of the series. The duration may be specified as a maximum number of bonus games in the series. The duration may be specified as a time interval.

In certain embodiments, in the displayed game options there is an inverse relationship between the duration of the series and the designated number of reels having at least one specified symbol in the associated set of symbols.

In certain embodiments, the expected player return is the same for at least two of the displayed game options.

In certain embodiments, the gaming machine is operable to receive an extra payment and to increase an expected player return in the feature game if the extra payment is received.

In certain embodiments, the number or type of said game options available to be chosen depends on the size of a wager received from a player.

According to a further aspect of the present invention, there is provided a gaming apparatus providing a game in which a plurality of game symbols are displayed in a respective number of symbol positions to form one or more outcomes and if a particular outcome occurs the gaming apparatus awards an award, each symbol position having an associated set of symbols available for display in the symbol position, the gaming apparatus comprising:

a display that displays a plurality of game options on the display, each game option designating a respective number of the associated sets of symbols as having at least one specified symbol; and

a game controller in data communication with the display and arranged to:

(a) receive an input choosing one of the displayed game options; and

(b) play a game according to the chosen game option, wherein for each symbol position at least one symbol is displayed on the display, the occurrence of at least one of said particular outcomes of the game depending on the display of at least one specified symbol, each specified symbol providing modified play characteristics relative to other symbols in the set of symbols.

According to a further aspect of the invention there is provided a computer program product comprising machine-readable program code recorded on a machine-readable recording medium, for controlling the operation of a data processing apparatus on which the program code executes to perform a method of providing a game in which a plurality of spinning reels is displayed, each reel displaying at least one symbol from an associated set of symbols and if a particular outcome occurs an award is awarded, the method comprising:

displaying a plurality of game options, each game option designating a respective number of the reels as having at least one specified symbol in the associated set of symbols;

receiving a selection of one of the displayed game options; and

playing a game according to the received selection, wherein for each spinning reel at least one symbol is randomly selected and displayed, the display of at least one of said specified symbols providing modified play characteristics relative to other symbols in the set of symbols.

According to a further aspect of the invention there is provided a computer program comprising machine-readable program code for controlling the operation of a data processing apparatus on which the program code executes to perform a method of providing a game in which a plurality of spinning reels is displayed, each reel displaying at least one symbol from an associated set of symbols and if a particular outcome occurs an award is awarded, the method comprising:

displaying a plurality of game options, each game option designating a respective number of the reels as having at least one specified symbol in the associated set of symbols;

receiving a selection of one of the displayed game options; and

playing a game according to the received selection, wherein for each spinning reel at least one symbol is randomly selected and displayed, the display of at least one of said specified symbols providing modified play characteristics relative to other symbols in the set of symbols.

According to another aspect of the invention, there is provided a gaming apparatus comprising an electronic processing system that is arranged to allow a player to select one or more reels, of a reel-based game, on which a special symbol may appear.

In certain embodiments, the electronic processing system is arranged to allow the player to select the reels subsequent to a feature game trigger event occurring.

In certain embodiments, the electronic processing system is arranged to allow the player to provide a number of free plays of the reel-based game, wherein the number of free plays is based on the one or more reels selected by the player.

Further aspects of the present invention will become apparent from the following description, given by way of example only and with reference to the accompanying drawings.

### BRIEF DESCRIPTION OF THE DRAWINGS

The present invention will now be described, by way of example only, with reference to the accompanying drawings, in which:

FIG. 1 shows schematically a view of a gaming machine suitable for implementing certain embodiments of the present invention.

FIG. 2 shows a block diagram of gaming apparatus suitable for implementing certain embodiments of the present invention.

FIG. 3 shows a block diagram of components of the memory of the gaming apparatus represented in FIG. 2.

FIG. 4 shows schematically a network gaming system suitable for implementing certain embodiments of the present invention.

FIG. 5 shows a flow diagram of a game process to be implemented by a gaming apparatus or a gaming system and having a game feature.

FIG. 6 shows schematically a screen shot of a configuration in which the feature game is triggered in the method of FIG. 5.

FIG. 7 shows a screen display enabling a user to select options in the feature game.

FIG. 8 shows an example of a game result in the feature game.

### DETAILED DESCRIPTION

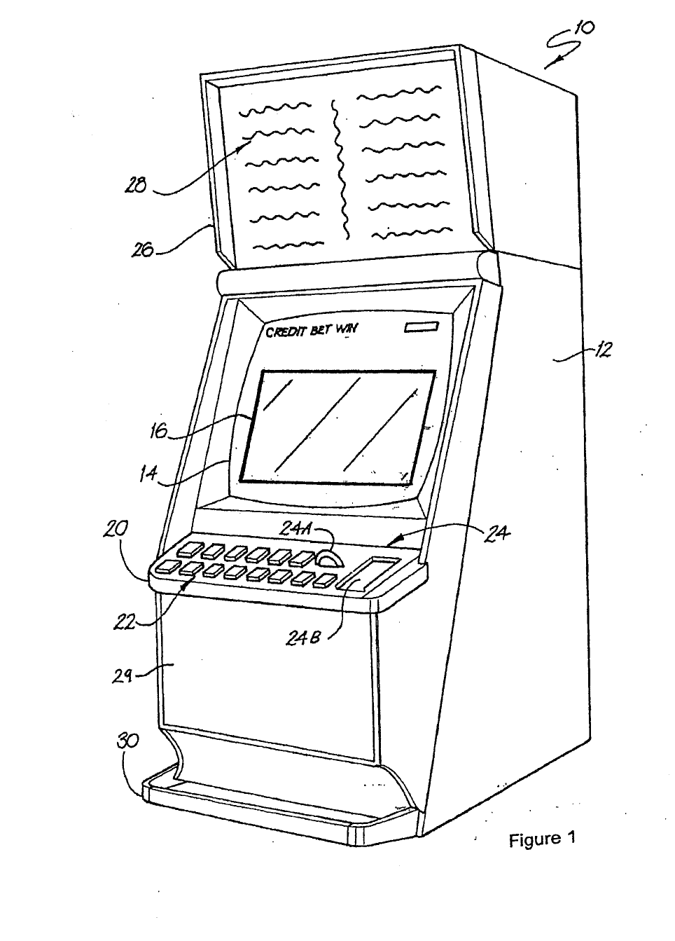

In FIG. 1 of the accompanying drawings, one example of a gaming machine embodying the present invention is generally referenced by arrow 10.

The gaming machine 10 includes a console 12 having a display 14 on which is displayed representations of a game 16 that can be played by a player. A mid-trim 20 of the gaming machine 10 houses a bank of buttons 22 for enabling a player to play the game 16. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 12. A coin tray 30 is mounted beneath the console 12 for cash payouts from the gaming machine 10.

The display 14 shown in FIG. 1 is in the form of a video display unit such as a cathode ray tube (CRT) screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or a different type of display.

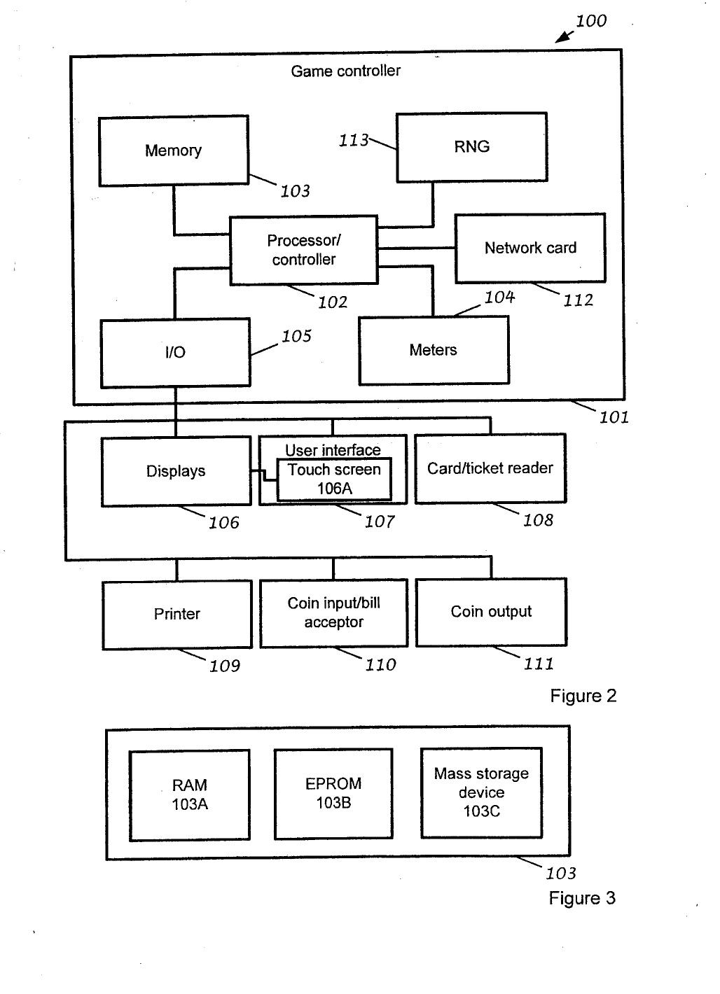

FIG. 2 shows a block diagram of a gaming apparatus, generally referenced by arrow 100, suitable for implementing certain embodiments of the present invention. The gaming apparatus 100 may, for example, operate as a stand alone gaming machine of the type shown in FIG. 1. However, the gaming apparatus 100 may alternatively operate as a networked gaming machine, communicating with other network devices, such as one or more servers or other gaming machines. The gaming apparatus 100 may also have distributed hardware and software components that communicate with each other directly or through a network. Accordingly, different reference numerals have been used in FIG. 2 and FIG. 1 for components that may be equivalent.

The gaming apparatus 100 includes a game controller 101, which in the illustrated example includes a microprocessor, microcontroller, programmable logic device or other computational device 102. Instructions and data to control operation of the computational device 102 are stored in a memory 103, which is in data communication with the computational device 102. Typically, the gaming apparatus 100 will include both volatile and non-volatile memory and more than one of each type of memory, with such memories being collectively represented by the memory 103. The instructions to cause the game controller 101 to implement the present invention are stored in the memory 103.

The gaming apparatus may include meters 104 for the purposes of regulatory compliance and may also include an input/output (I/O) interface 105 for communicating with the peripheral devices of the gaming apparatus 100. The input/output interface 105 and/or the peripheral devices may be intelligent devices with their own memory for instructions and data.

The gaming apparatus includes a random number generator (RNG) 113, which may be a software module running on the computational device 102. Alternatively, the RNG may be implemented on a separate processor, either as software running on a microprocessor or on a dedicated hardware unit such as an application-specific integrated circuit (ASIC).

In the example shown in FIG. 2, the peripheral devices that communicate with the controller 101 are one or more displays 106, user interfaces 107, a card and/or ticket reader 108, a printer 109, a bill acceptor and/or coin input mechanism 110 and a coin output mechanism 111.

One or more of the displays 106 may include a touch screen 106A that forms part of the user interface 107. Additional devices may be included as part of the gaming apparatus 100, or devices omitted as required for the specific implementation.

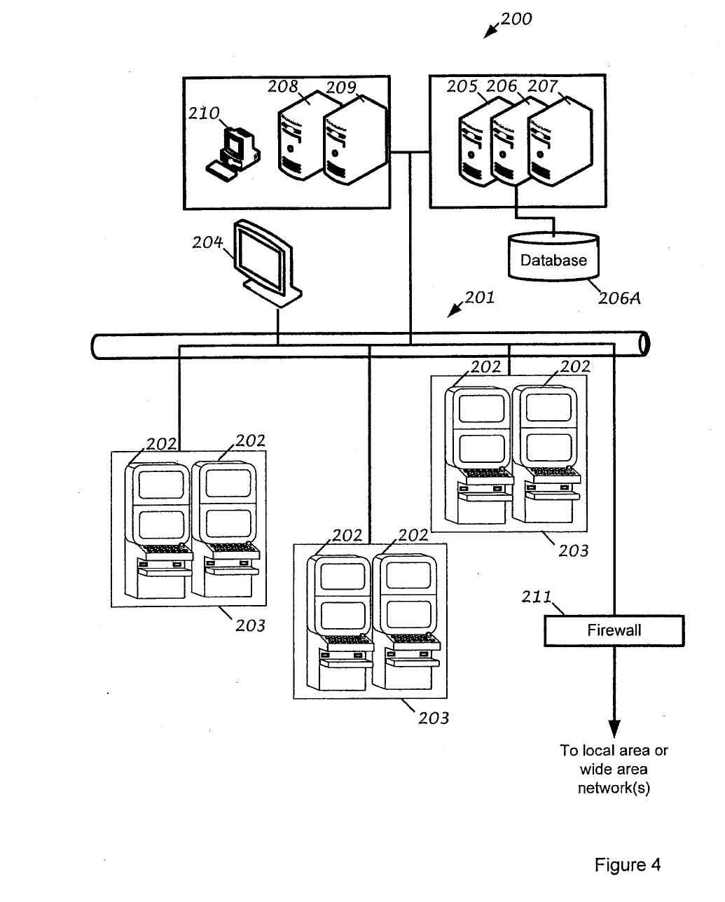

In addition, the gaming apparatus 100 may include a communications interface, for example a network card 112. The network card, may for example, send status information, accounting information or other information to a central controller, server or database and receive data or commands from the central controller, server or database. As explained in more detail in relation to FIG. 4, the computational device 102 may include two or more controllers or processors, which may be local or remote from each other and the displays 106.

FIG. 3 shows an exemplary block diagram of the main components of the memory 103. The RAM 103A typically temporarily holds program files for execution by the computational device 102 and related data. The EPROM 103B may be a boot ROM device and/or may contain some system- or game-related code. The mass storage device 103C is typically used to store game programs, the integrity of which may be verified and/or authenticated by the computational device 102 using protected code from the EPROM 103B or elsewhere.

FIG. 4 shows a gaming system 200. The gaming system 200 includes a network 201, which for example may be an Ethernet network. Gaming devices 202, shown arranged in three banks 203 of two gaming devices 202 in FIG. 4, are connected to the network 201. The gaming devices 202 may be gaming machines 10, as shown in FIG. 1 or may form part or all of another gaming apparatus 100. Single gaming devices 202 and banks 203 containing three or more gaming devices 202 may also be connected to the network 201.

One or more displays 204 may also be connected to the network 201. The displays 204 may, for example, be associated with a bank 203 of gaming devices. The displays 204 may be used to display representations associated with game play on the gaming devices 202, and/or used to display other representations, for example promotional or informational material.

Servers may also be connected to the network 201. For example, a game server 205 may generate game outcomes for games played on the gaming devices 202, a database management server 206 may manage the storage of game programs and associated data for downloading or access by the gaming devices 202 in a database 206A, and a jackpot server 207 may control one or more jackpots associated with the gaming devices 202.

Further servers may be provided to assist in the administration of the gaming system 200, including for example a gaming floor management server 208, and a licensing server 209 to monitor the use of licenses to particular games. An administrator terminal 210 is provided to allow an administrator to run the network 201 and the devices connected to the network.

The gaming system 200 may communicate through a firewall 211 with other gaming systems or other local networks, for example a corporate network and/or a wide area network such as the Internet.

The following description of the game of certain embodiments of the present invention is given by way of example of the most preferred embodiment as presently contemplated, as a feature game of a base game and as a spinning reel game. However, the game of certain embodiments of the present invention may be a standalone game or a base game of one or more feature games. Also, certain embodiments of the present invention are not limited to spinning reel games and could be applicable to card games, dice games, or other games that allow a selection of symbols for symbol positions and allow variation in the number of a particular special symbol that is available to be selected in one or more symbol positions.

Triggering the Feature Game

During play of a base game, the player is offered the opportunity to play a feature game. The base game may be played, for example, on gaming machine 10, gaming apparatus 100 or gaming system 200. The opportunity to play the feature game may be triggered in many ways. For example, the feature game may be triggered randomly using a number generated by the random number generator (RNG) 113. The triggering event may be a specified time, or may be associated with a specified turnover, either of a single machine such as gaming apparatus 100 or a plurality of machines as in gaming system 200. The triggering event may be the collection of a certain number of tokens.

The feature game may be triggered when a specified combination of symbols occurs in the base game. The specified combination may be advertised on the gaming machine 10, for example on the front panel 24 or the top box 26. Alternatively, the feature may be triggered when a non-advertised combination occurs. Other triggers may involve the occurrence of one or more specified game states or console states.

External trigger events may initiate the feature game, for example a signal received from game server 205. Specified operator activities or player activities may be used to trigger the feature game, which may also be associated with a special bet or a tournament. The trigger may come from the base game or from a system associated with the game.

Choices Provided in Feature Game

Once the feature game has been triggered, the player is presented with a plurality of game options. In each game option the player is offered a series of bonus games. In each bonus game, a plurality of spinning reels is displayed on the gaming machine 10. Associated with each game option is a designated number of spinning reels on which certain special symbols may appear. Game options that offer more bonus games have fewer spinning reels on which the special symbols may appear during the bonus games. There is thus an inverse relationship between the duration of the series and the number of designated reels having special characters in each game option.

The player selects a game option, for example using touch screen 106A or user interface 107, and the processor 102 acts to display the selected series of bonus games on the displays 106. In each bonus game the spinning reels are animated to appear to spin. When the spinning ceases, a randomly selected array of symbols is displayed on the stationary reels. The symbols may, for example, be selected using the random number generator 113. At least some of the winning configurations in the bonus games are dependent on the special symbols. Thus, the fewer bonus games chosen by the player, the higher the probability of a winning configuration in any one bonus game, and vice versa.

The paytables corresponding to the different options may be specified such that the expected player return is constant regardless of which option is chosen. Thus the return to player may be kept constant by maintaining an inverse relationship between the number of opportunities for winning and the probability of a winning outcome in each of the opportunities.

Each series of bonus games presented in the different game options has a fixed duration, defined either by the number of bonus games in the series or by a time interval. The feature may include a re-trigger, which may result in more free games or in the display of another selection screen.

The feature game may be designed to terminate if specified criteria are met. For example, the feature game may cease when a maximum prize value is reached. This may be in accordance with requirements in the jurisdiction in which the gaming machine operates. In a further example, play of the bonus games may involve the spinning up of particular symbols that are counted. The feature game may then continue until a specified number of symbols are collected and then end. A jackpot amount may be awarded if the specified number of symbols is collected.

When the feature game is triggered, the gaming machine presents the player with a plurality of game options. The game options may differ from one another in one or more of the following aspects:

the number or location of the reels may differ between game options;

different types of bonus game may be offered in different game options;

different types of special symbol may be offered in different game options;

the duration of the series of bonus games may differ in different game options; and

the paytables associated with the game options may differ.

The type of bonus games offered in the game options may vary. For example, the bonus games may be free games. Alternatively, the bonus games may be hold-and-respin games in which the player may elect to hold one or more reels as displayed, and respin one or more of the remaining reels displayed in the bonus game. The bonus games may be purchased games with special features. The bonus games may also be repeat win games that remember a trigger feature and repeat the feature if a specified triggering event occurs.

Different game options may offer games that use different numbers of reels. For example, a 4 by 5 array of lines and reels may be provided in one game while other games may use a 5 by 5 array of symbols.

One or more of the game options may offer the possibility of a progressive win. For example 4 scatter symbols may win a jackpot.

In one arrangement the player has the option of paying extra money to get an extra feature offered which has a better return. The extra money may be paid at the start of the base game from which the feature game is triggered. The gaming apparatus on which the game is played may have an ante-bet, or bash button, for example amongst the buttons 22 or on a touch screen. Using the ante-bet, the player may choose, for example, to pay an extra 5 credits per spin in the base game. The consequence of this extra payment is that, if the feature game is triggered, options are displayed that are more favourable to the player. In one arrangement the ante-bet increases the likelihood of the feature being triggered. The amount of the ante-bet is game specific. The ante-bet may be offered as an additional stake regardless of how many lines or reels are being played. Alternatively the player may be offered more favourable options if the player has bet more per line or more per reel.

Examples of the Special Symbols

In choosing between game options, the player determines the number of reels on which special symbols may appear during the feature game. Each reel displayed in the feature game has an associated set of symbols. When the reel is spun during the feature game, symbols from the associated set are rendered to the display 106. Each reel may display a plurality of symbols and thus an array of symbols is rendered to the display.

The special symbols may be wild symbols that can substitute for other symbols in the feature game. Wild symbols thus contribute to the winning combinations specified for the game. Wild symbols may be associated with a multiplier or a range of multipliers. That is, if the wild symbol is selected and displayed on display 106, the payout associated with a winning combination may be multiplied by the multiplier.

If a wild symbol is associated with a range of multipliers, there are various ways in which a multiplier may be selected from the range. For example, the multiplier may depend on which reel the wild symbol is displayed. The multiplier may vary depending on how many wild symbols are substituted in a winning combination. Alternatively, the multiplier may be selected at random from the range, for example using random number generator 113.

Multipliers arising from the occurrence of wild symbols may be cumulative. In other arrangements, only a single multiplier is applied.

Wild symbols may be stretch wilds that may substitute for symbols not only in the wild symbol's location but also in other locations. This typically includes symbols directly above and below the stretch wild. The wild symbols may be sticky. A sticky wild persists between game plays. In some arrangements wild symbols may be added to the set associated with one or more reels after a spin.

The special symbols associated with different game options may be scatter symbols. The contribution of a scatter symbol in a winning hand does not depend on the position of the scatter symbol in reel. In one arrangement left to right scatter symbols may change to ‘all scatter pays’ symbols for the number of reels that have been chosen. For ‘all scatter pays’ symbols, there does not need to be a predefined order of scatter symbols from left to right (or right to left) to provide a win.

The special symbols associated with one or more game options may be symbols that, if selected and displayed, trigger a respin or more free games. Special symbols that have this effect may be wild symbols, scatter symbols, or another predefined symbol.

The special symbol may be a token-building symbol that, if selected and displayed, attributes an additional token to the player. The tokens may contribute to a jackpot win, a progressive win, a retrigger or a bonus prize. Special symbols that have this effect may be wild symbols, scatter symbols, or another predefined symbol.

The special symbols may include a symbol, or range of symbols, that become wild or scattered during the feature game.

The special symbols may have the property that, if displayed, the special symbol automatically reveals a player reward, for example a random prize or a free game.

The special symbols may include one or more symbols that, upon display, trigger a further game feature. In one arrangement these symbols are scatter symbols. The special symbols may appear in the regular or base game from which the feature game is triggered.

The special symbols may include one or more symbols that, upon display, trigger a repeat win of the amount of credits associated with the event in the base game that triggered the feature game. The special symbols may include symbols that trigger an award of a fixed amount.

A special symbol may be a ‘reveal’ symbol that, if selected and displayed, reveals another game symbol. The reveal symbol may reveal another prize or multiplier.

A special symbol may be a ‘nudge’ symbol that, if displayed, permits the player to shift the position of the symbol to a position that results in a winning outcome or another winning outcome with a higher award.

Description of Method

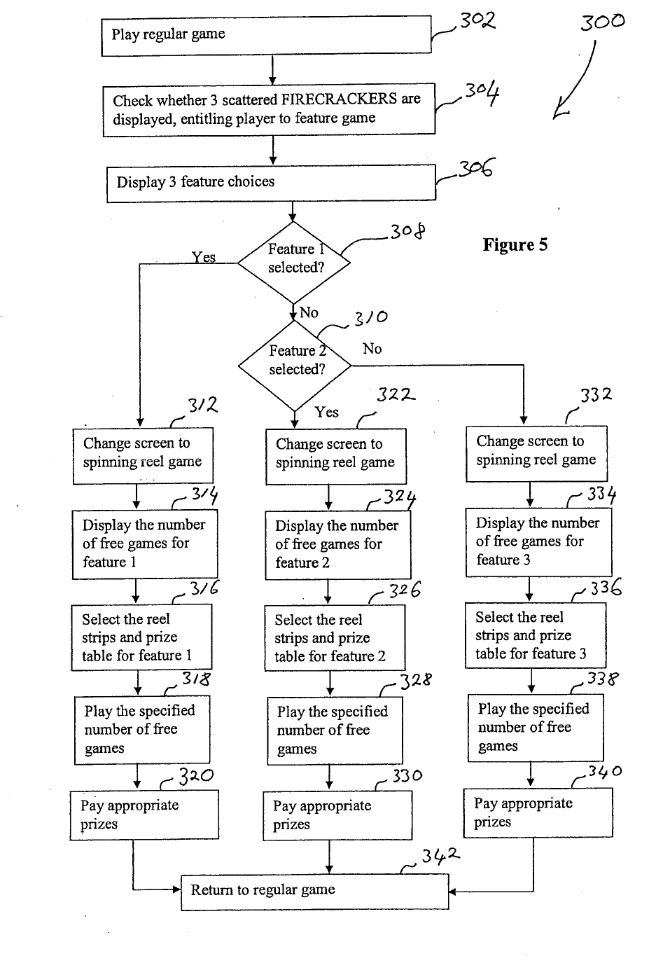

FIG. 5 shows a flow diagram of a particular embodiment of a method 300 of providing a feature game. Initially, in step 302, the player plays the base game, which in this instance is a five reel spinning reel game with an advertised prize schedule. In the base game, the symbols include a wild symbol available only on reels 2 and 4. In the described arrangement, the wild symbol is a firecracker.

In the embodiment shown, the feature is triggered by the occurrence of three or more scattered Catherine wheel symbols. In step 304, software running on computational device 102 checks whether three or more Catherine wheel symbols are displayed anywhere on the display, thereby entitling the player to a feature game. As explained previously herein other trigger events could be used. In one alternative embodiment, the trigger event may be the occurrence of a predetermined number of the special symbols in the base game, with more of the special symbols appearing in the feature game or the characteristics of the special symbols changing in the feature game.

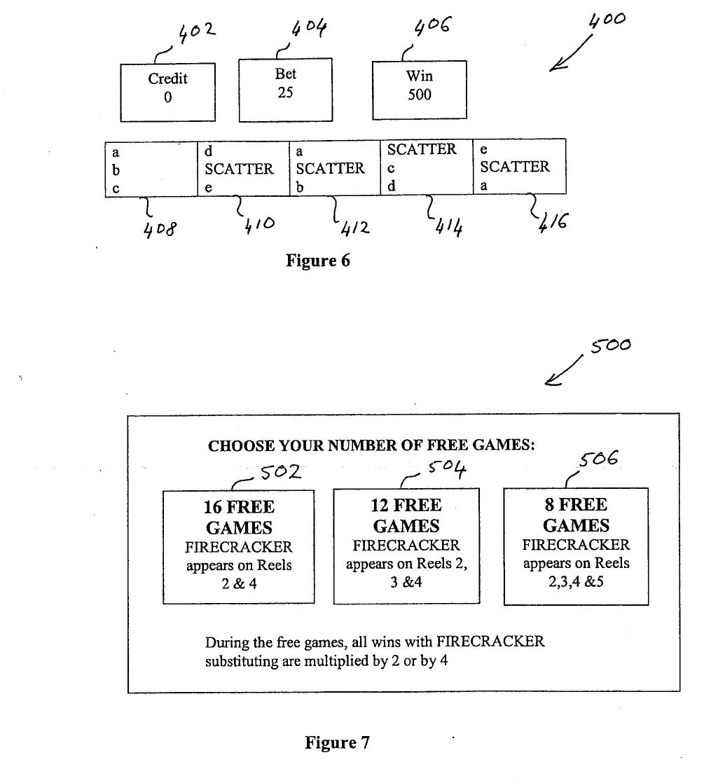

FIG. 6 shows a schematic diagram of a hypothetical screen shot 400 displayed on display 106 in the regular or base game. The combination of symbols in screen shot 400 entitles a player to a feature game. The screen shot 400 shows five reels 408, 410, 412, 414 and 416. Each reel has three lines. Reel 408 shows three symbols, designated ‘a’, ‘b’ and ‘c’. Reel 410 shows ‘d’, a scatter symbol on the second line and symbol ‘e’ on the third line. Reel 412 shows symbol ‘a’, a scatter symbol and symbol ‘b’. Reel 414 shows a scatter symbol followed by symbols ‘c’ and ‘d’. Reel 416 shows symbol ‘e’ on the first line followed by a scatter symbol and symbol ‘a’. As shown at 402, the player currently has a credit of 0 units. As shown at 404, the player has bet 25 units, and as shown at 406 the simultaneous display of four scatter symbols has won the player 500 units.

In step 306, the computational controller 102 renders a new display to display 106 that offers the player three feature choices. An example 500 of three such choices is shown in FIG. 7. In game option 502, the player is offered the option of 16 free games in which the firecracker symbol is added to the sets of symbols associated with two of the reels. In game option 504, the player is given the option of 12 free games in which the firecracker symbol is added to the sets of symbols associated with three of the reels. In game option 506, the player is offered the option of 8 free games in which the firecracker symbol is added to the set of symbols associated with four the reels.

Screen display 500 informs the player that, during the free games, all wins in which the firecracker symbol substitutes are multiplied by either 2 or by 4. Software running on the processor 102 then checks whether the player has made a choice of one of the 3 options 502, 504 or 506. The player may indicate an option by, for example, touching the touch screen 106A. Alternatively, a player may push one of the buttons 22.

In step 308, the software running on the processor 102 checks whether the player has selected the first feature, i.e. game option 502. If so, then in step 312 the display on display 106 is changed to a spinning reel game for the feature game. In step 314 the game machine 10 displays the number of free games available in the selected feature. Then, in step 316, the software running on processor 102 selects from memory 103 the reel strips and prize table for the first feature. The step of selecting the reel strips is equivalent to designating the set of symbols associated with the spinning reels.

In step 318, the game controller 101 acts to play the specified number of free games. The appropriate prizes are paid in step 320, and then in step 342 process flow returns to the regular or base game.

If the player does not select feature 1, then in step 310 the game controller 101 checks whether the player has selected the second feature, i.e. game option 504. If the player has selected option 504, then the game controller performs steps 322-330. In step 322 the display 106 is updated to display the spinning reel game. In step 324, the number of free games remaining for the second game option 504 is displayed. In step 326 the reel strips and prize table are selected for the second game option 504. In step 328, the game controller acts to play the specified number of free games, and the appropriate prizes are paid in step 330. Thereafter, the processor returns to the base game in step 342.

If the player does not select the second option 504 in step 310 (the No option of step 310) then process flow proceeds to step 332, in which the screen is changed to the spinning reel game and, in step 334, the number of free games remaining for the third game option 506 is displayed.

In step 336, the game controller 101 selects the reel strips and prize table for the third game option 506. In step 338 the game controller acts to play the specified number of free games in the third option 506. The appropriate prizes are paid in step 340 and then in step 342 the processor player returns the base game.

In one arrangement, if the player does not make a choice when the screen 500 is displayed, the option is displayed indefinitely on display 106. In another arrangement, the choice screen 500 times out after a specified time interval and either a default selection of one of the three options is made, or a random selection of one of the three options 502, 504, 506 is made.

For each feature game, the prize table may be the same as that in the base game except that winning combinations achieved with a wild symbol are multiplied by 2 or 4. The multiplication factor is selected to achieve the required player return percentages.

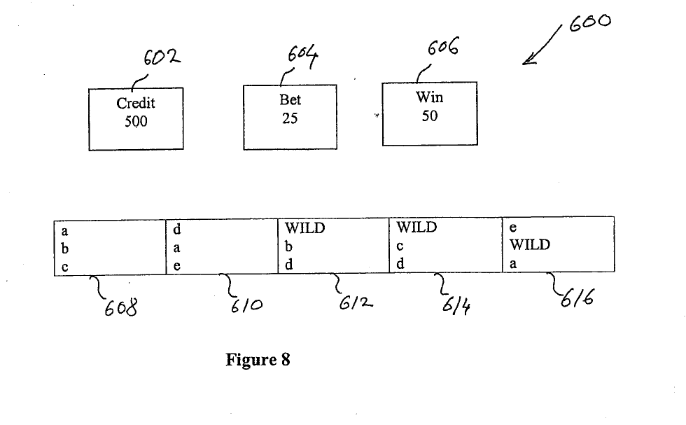

FIG. 8 shows an example 600 of a free game displayed on display 106 when the player has selected game option 506, in which the wild symbol may appear on any of reels 610, 612, 614 or 616. In the example 600, the wild symbol has been selected and displayed on reels 612, 614 and 616.

As seen in 602, the player has a credit of 500 due to the award in the base game. The player has bet 25 units as shown in 604 and the player has currently won 50 units, as shown at 606.

In one arrangement, any three or more scattered firecrackers appearing during a free game retrigger the feature. The same number of free games that the player initially selected is added to their current number of remaining free games. The feature then continues with the same reel strips.

While the foregoing description has been provided by way of example of certain embodiments of the present invention as presently contemplated, which utilise gaming apparatus and machines, those skilled in the relevant arts will appreciate that certain embodiments of the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

The claims defining the invention are as follows:

1. A method of providing a game played on a computational gaming apparatus having a display and a user interface, the game being a spinning reel game in which at least one symbol is spun up on each of a plurality of spinning reels and displayed on the display to form one or more outcomes and if a particular outcome occurs the gaming apparatus awards an award, each reel having an associated set of symbols, the method comprising:
displaying a plurality of game options, each game option designating a respective number of the spinning reels as having at least one specified symbol in the associated set of symbols;
receiving a selection of one of the displayed game options; and
playing the game according to the received selection, wherein for each spinning reel at least one symbol is randomly selected and displayed on the display, the display of at least one of said specified symbols providing modified play characteristics relative to other symbols in the set of symbols.

2. A method according to claim 1 wherein the modified play characteristics comprise an increased chance of a said particular outcome.

3. A method according to claim 1 wherein the modified play characteristics comprise a larger award if one or more said particular outcomes result from the game.

4. A method according to claim 1 wherein the displayed game is a feature game associated with a base game played on the computational gaming apparatus.

5. A method according to claim 1, wherein the method further comprises modifying a parameter of the game other than the number of spinning reels having at least one specified symbol in response to the selection of one of the displayed game options, the parameter of the game acting to maintain a return-to-player of the game constant for at least two of the displayed options.

6. A method according to claim 5 wherein, if the game is a feature game, the parameter of the game maintains a return-to-player for the base game and feature game collectively.

7. A method according to claim 1 wherein the game options each comprise a series of games and each game option comprises a duration of the respective series.

8. A method for use with a gaming machine that is arranged to select symbols, present the selected symbols on a display and award an award if a winning outcome occurs, the method comprising:
displaying a plurality of game options on the display for selection by a player, each game option defining a respective number of opportunities to win and a corresponding probability of winning in each opportunity, wherein at least two of the displayed game options have a substantially equal return-to-player.

9. A method according to claim 8 wherein the respective number of opportunities to win is inversely dependent on the corresponding probability of winning.

10. A method according to claim 8 wherein the corresponding probability of winning for a game option depends on a number of spinning reels having an associated special symbol.

11. A gaming apparatus providing a game in which a plurality of spinning reels is displayed, each reel displaying at least one symbol from an associated set of symbols to form one or more outcomes and if a particular outcome occurs the gaming apparatus awards an award, the gaming apparatus comprising:
a display that displays a plurality of game options, each game option designating a respective number of the reels as having at least one specified symbol in the associated set of symbols; and
a game controller in communication with the display and arranged to:
(a) receive an input choosing one of the displayed game options; and
(b) play a game according to the chosen game option, wherein for each spinning reel at least one symbol is randomly selected and displayed on the display, the display of at least one of said specified symbols providing modified play characteristics relative to other symbols in the sets of symbols.

12. A gaming apparatus according to claim 11 wherein the game is a feature game and the gaming apparatus is operable to trigger commencement of the feature game during a base game played on the gaming apparatus.

13. A gaming apparatus according to claim 11 wherein the displayed feature game comprises a series of bonus games and each game option designates a duration of the series.

14. A gaming apparatus according to claim 11 wherein the duration is specified as a maximum number of bonus games in the series.

15. A gaming apparatus according to claim 11 wherein the duration is specified as a time interval.

16. A gaming apparatus according to claim 11 wherein in the displayed game options there is an inverse relationship between the duration of the series and the designated number of reels having at least one specified symbol in the associated set of symbols.

17. A gaming apparatus according to claim 11 wherein an expected return-to-player is the same for at least two of the displayed game options.

18. A gaming apparatus according to claim 11 wherein the gaming apparatus is operable to receive an extra payment and to increase an expected player return in the feature game if the extra payment is received.

19. A gaming apparatus according to claim 11 wherein the number or type of said game options available to be chosen depends on the size of a wager received from a player.

20. A gaming apparatus providing a game in which a plurality of game symbols are displayed in a respective number of symbol positions to form one or more outcomes and if a particular outcome occurs the gaming apparatus awards an award, each symbol position having an associated set of symbols available for display in the symbol position, the gaming apparatus comprising:
a display that displays a plurality of game options on the display, each game option designating a respective number of the associated sets of symbols as having at least one specified symbol; and
a game controller in data communication with the display and arranged to:
(a) receive an input choosing one of the displayed game options; and
(b) play a game according to the chosen game option, wherein for each symbol position at least one symbol is displayed on the display, the occurrence of at least one of said particular outcomes of the game depending on the display of at least one specified symbol, each specified symbol providing modified play characteristics relative to other symbols in the set of symbols.

21. A gaming apparatus comprising an electronic processing system that is arranged to allow a player to specify a number of reels in a reel-based game, wherein each of the specified reels has an associated set of symbols for display that includes a special symbol.

22. A gaming apparatus according to claim 21 wherein the electronic processing system is arranged to allow the player to specify the reels subsequent to a feature game trigger event occurring.

23. A gaming apparatus according to claim 21 wherein the electronic processing system is arranged to allow the player a number of free plays of the reel-based game, wherein the number of free plays is based on the number of reels specified by the player.

24. A computer program product comprising machine-readable program code recorded on a machine-readable recording medium, for controlling the operation of a data processing apparatus on which the program code executes to perform a method of providing a game in which a plurality of spinning reels is displayed, each reel displaying at least one symbol from an associated set of symbols and if a particular outcome occurs an award is awarded, the method comprising:
displaying a plurality of game options, each game option designating a respective number of the reels as having at least one specified symbol in the associated set of symbols;
receiving a selection of one of the displayed game options; and
playing a game according to the received selection, wherein for each spinning reel at least one symbol is randomly selected and displayed, the display of at least one of said specified symbols providing modified play characteristics relative to other symbols in the set of symbols.

25. A computer program comprising machine-readable program code for controlling the operation of a data processing apparatus on which the program code executes to perform a method of providing a game in which a plurality of spinning reels is displayed, each reel displaying at least one symbol from an associated set of symbols and if a particular outcome occurs an award is awarded, the method comprising:
displaying a plurality of game options, each game option designating a respective number of the reels as having at least one specified symbol in the associated set of symbols;
receiving a selection of one of the displayed game options; and
playing a game according to the received selection, wherein for each spinning reel at least one symbol is randomly selected and displayed, the display of at least one of said specified symbols providing modified play characteristics relative to other symbols in the set of symbols.
